(19) United States
(12) Patent Application Publication
(10) Pub. No.: US 2026/0173095 A1
(43) Pub. Date: Jun. 18, 2026

(54) EARLY INDICATION/INFERENCE OF NR NARROW CHANNEL BANDWIDTH OPERATION

(71) Applicant: TELEFONAKTIEBOLAGET LM ERICSSON (PUBL), STOCKHOLM (SE)

(72) Inventors: Kazuyoshi Uesaka, Yokohama (JP); Kittipong Kittichokechai, Stockholm (SE); Gerardo Agni Medina Acosta, Stockholm (SE); Mirza Uzair Baig, Stockholm (SE); Dominique Everaere, Stockholm (SE)

(21) Appl. No.: 19/128,548

(22) PCT Filed: Nov. 8, 2023
(86) PCT No.: PCT/IB2023/061293

§ 371 Date: May 8, 2025

Related U.S. Application Data
(60) Provisional application No. 63/423,728, filed on Nov. 8, 2022.

(51) Int. Cl. H04W 72/23; H04L 5/00; H04W 72/0453

(52) U.S. Cl. CPC H04W 72/23; H04L 5/0048; H04L 5/0053; H04W 72/0453

(57) ABSTRACT

Systems and methods are disclosed for early indication or inference of a narrow channel bandwidth in a wireless network. In one embodiment, a method performed by a User Equipment (UE) in a wireless network comprises determining, based on an explicit or implicit early indication or implicit inference, that the UE is to operate in accordance with a narrow channel bandwidth. The method further comprises operating in accordance with a result of the determining. In this manner, UEs designed to operate in larger bandwidths can make sue of the early indication/inference for decoding purposes, thereby improving performance. Embodiments of a network node and embodiments of a method of operation of a network node are also disclosed.

### RELATED APPLICATIONS

This application claims the benefit of provisional patent application Ser. No. 63/423,728, filed Nov. 8, 2022, the disclosure of which is hereby incorporated herein by reference in its entirety.

### TECHNICAL FIELD

The present disclosure relates to a wireless communication network and, more specifically, to early indication or inference of a narrow channel bandwidth.

### BACKGROUND

At 3^{rd} Generation Partnership Project (3GPP) meeting RAN #94-e, a new Work Item (WI) on “NR support for dedicated spectrum less than 5 MHz for FRI” was approved (see RP-213603, “NR support for dedicated spectrum less than 5 MHz for FR1,” 3GPP TSG RAN meeting #94e, Electronic Meeting, Dec. 6-17, 2021.).

The Work Item Description (WID) (see RP-213603) relates to the use cases of Future Railway Mobile Communication System (FRMCS), utilities, and public safety for which the following has been highlighted as part of the WID's justification as shown in the extract from the WID below:
Rail Communication in Europe is used for operational purposes to ensure the safety of millions of rail passengers. The Future Railway Mobile Communication System (FRMCS) forms the basis for digitizing rail operations with the aim of increasing train path utilization and improving punctuality. For the use of the harmonized 900 MHz spectrum block (2×5.6 MHz FDD), for a period of approximately 10 years from 2025 onwards, constraints stem from the need to operate in parallel FRMCS and the currently deployed and operational GSM-R system. Depending on the traffic volume and location, GSM-R requires a significant portion of the 4 MHz according to the GSM-R band definition (according to 3GPP TS 45.005), although this is expected to reduce as traffic migrates from GSM-R to FRMCS. Consequently, possibilities in 5G NR to operate in bandwidths <5 MHz (e.g., from around 3 MHz upwards) would enable parallel operation of FRMCS and GSM-R and massive infrastructure reuse.
Around 1 million rail vehicles are registered in Europe. The vehicles, mostly closed train compositions with two driving heads, which are already equipped with GSM-R today, usually have 2 GSM-R UEs up to 6 UEs when European Train Control System is used. This group of vehicles makes up around 10%. It is expected that a second group of rail vehicles (approx. 40%) will be equipped with FRMCS capabilities during the course of the next decade. Upgrading the remaining vehicles with FRMCS is done in a broader schedule. The responsible authorities and organizations in Europe have set the start of the migration from GSM-R to FRMCS for 2025.
The provision of simultaneous use of the 2×5.6 MHz FDD in the 900 MHz frequency band and the associated provision of bandwidths less than 5 MHz for 5G NR thus has a key function in order to be able to start the migration from GSM-R to FRMCS in Europe.
In summary, FRMCS plays a key role in the automation of rail operations. It is anticipated that this will lead to a significant improvement in route utilization and thus also contribute to the reduction of greenhouse gases.
For Public Protection and Disaster Relief (PPDR), 2×3 MHz FDD in band 28 has been identified in Europe.
NR specifications starting in Rel-15 defined a minimum bandwidth of 5 MHz channels. Although NR can support multiple channel bandwidths due to the flexible numerology implementation, channel bandwidths smaller than this are currently not supported in NR. The minimum PRB size in multiples of 4 and the size of the PBCH are the determining factors in not being able to scale to smaller than 5 MHz channel bandwidths.

In line with the WID's justification, the following 3GPP Release (Rel-) 18 objectives for RAN1 have been defined:

The following objectives shall be included for dedicated FDD spectrum in FR1:
Identify and specify necessary changes to NR physical layer with minimum specification impact to operate in spectrum allocations from approximately 3 MHz up to below 5 MHz [RAN1]:
   Restrict to subcarrier spacing of 15 kHz and the use of normal cyclic prefix.
   For SSB:
      Reuse PSS/SSS specification without puncturing.
      PBCH based on current design
   Identify and specify necessary minimum changes to PDCCH, CSI-RS/TRS, PUCCH, and PRACH for functional support based on existing design, without optimization.

The WID explicitly mentions a set of physical channels (i.e., Synchronization Signal Block (SSB), Physical Downlink Control Channel (PDCCH), Physical Uplink Control Channel (PUCCH), and Physical Random Access Channel (PRACH)) and signals (i.e., Channel State Information (CSI) Reference Signal (CSI-RS)/Tracking Reference Signal (TRS)) that need to be investigated as to identify and specify necessary changes to them to operate in spectrum allocations from approximately 3 Megahertz (MHz) up to below 5 MHz.

As part of the background, an overview of the physical channels and signals mentioned in the WID is provided below.
1) SSB

The most fundamental aspects of SSB can be summarized as follows (see, e.g., 3GPP TS 38.211, “NR; Physical channels and modulation”, version 17.3.0, 3GPP Technical specifications and 3GPP TS 38.213, “NR; Physical layer procedures for control”, version 17.3.0, 3GPP Technical specifications):
An SSB contains the Primary Synchronization Signal (PSS), Secondary Synchronization signal (SSS), Physical Broadcast channel (PBCH) along with the Demodulation Reference Signal (DMRS).
   Broadcast Channel (BCH) carries the Master Information Block (MIB)
In frequency domain, one SSB block occupies 20 contiguous resource blocks (RBs) which is equivalent to 240 subcarriers, as illustrated in FIG. 1. In time domain, one SSB block spans over four Orthogonal Frequency Division Multiplexing (OFDM) symbols. Among the four symbols, one symbol is for PSS, one symbol is for SSS, and two symbols are for PBCH. Specifically, PSS occupies the first OFDM symbol of SSB and spans over 127 subcarriers. SSS is located in the third OFDM symbol of SSB and spans over 127 subcarriers. The total number of resource elements (REs) used for PBCH transmission per SSB is 576. There are, however, 113 unused subcarriers in the first symbol, and 17 unused subcarriers in the third symbol, as shown in FIG. 1. Therefore, there are 130 unused resource elements (REs) within an SSB. In the current 3GPP New Radio (NR) design, the complex-valued symbols corresponding to these unused REs are set to zero. One or more SSBs can be transmitted per synchronization signal (SS) burst in accordance with the Table 1 below.
“Cell search” for “SS/PBCH block” (i.e., SSB) accounts for different carrier frequencies and subcarrier spacings:
   Within one half-frame, there are several occurrences of SSBs.
   The SSBs can be located in the first or second half of the frame as indicated via MIB.
   One or multiple SSBs (i.e., a group of occurrences) compose an SS burst.
   The SS burst periodicity can be 5 milliseconds (ms), 10 ms, 20 ms, 40 ms, 80 ms, or 160 ms.

TABLE 1
Max number of SSBs per SS burst depending
on SCS and carrier frequency

| | | Maximum number of SSBs per SS burst | | |
|---|---|---|---|---|
| | SCS (kHz) | f_{c} < 3 GHz | 3 GHz ≤ f_{c} ≤ 6 GHz | 6 GHz < f_{c} |
| Case A | 15 | 4 | 8 | |
| Case B | 30 | 4 | 8 | |
| Case C | 30 | 4 | 8 | |
| Case D | 120 | | | 64 |
| Case E | 240 | | | 64 |

The time-frequency structure of the SSB is depicted in FIG. 1.

Today's SSB structure with 15 kilohertz (kHz) subcarrier spacing (SCS) results in ˜3.6 Megahertz (MHz) occupancy in the frequency-domain. Hence, either applying a puncturing technique or an SSB structure modification will be needed for fulfilling the WID's objective. RAN1 should evaluate first whether puncturing SSB is feasible performance-wise as to be supported in NR spectrum “from approximately 3 MHz up to below 5 MHz”.

### 2) PDCCH

Today prior to Rel-18, PDCCH for NR overall has the following characteristics:
PDCCH is mapped to a specific Control Resource Set (CORESET).
PDCCH occupies 1, 2, 4, 8, or 16 Control Channel Elements (CCEs).
   1 CCE corresponds to 6 Resource Element Groups (REGs).
      1 REG equals to 1 Resource Block (RB) in 1 OFDM symbol.
The CCE-to-REG mapping depends on a specific time-frequency resource configuration of a CORESET that spans up to 3 symbols in the time-domain.
The CCE-to-REG mapping can utilize one of the two following approaches:
   Interleaved mapping (always applied in CORESET 0)
   Non-Interleaved mapping

PDCCH is mapped to a specific CORESET. Thus, the highest “Aggregation level” that can be used depends on the resource blocks in the frequency domain according with

$$“ {N}_{RB}^{CORESET} ” and symbols “ {N}_{symb}^{CORESET} ”$$

### 3) CORESET 0

In frequency domain, a CORESET can span over one or multiple chunks of 6 RBs. For CORESETs other than CORESET 0, multiple chunks of 6 RBs can be either contiguous or non-contiguous, and the starting RB of a CORESET is determined based on clause 10.1 in 3GPP TS 38.211. On the other hand, CORESET 0 (which is configured and used during the initial access), can only have 24, 48, or 96 RBs.

For CORESET 0 configured by the ControlResourceSetZero Information Element (IE):

$${N}_{RB}^{CORESET} and {N}_{symb}^{CORESET}$$

are defined by clause 13 of 3GPP TS 38.331 V17.1.0;
the UE may assume interleaved mapping
L=6; This variable refers to the REG bundle size.
R=2; This variable refers to the Interleaver size.

$${n}_{shift} = {N}_{ID}^{cell} ;$$

the UE may assume normal cyclic prefix when CORESET 0 is configured by MIB or SIB1;
the UE may assume the same precoding being used within a REG bundle.

Moreover, CORESET 0 must be contiguous in frequency domain and only supports interleaved CCE-to-REG mapping (see 3GPP TS 38.312 V17.2.0).
REG bundle i is defined as REGs {iL, iL+1, . . . , iL+L−1} where L is the REG bundle size,

$$i = 0 , 1 , … , {N}_{REG}^{CORESET} / L - 1 , and {N}_{REG}^{CORESET} = {N}_{RB}^{CORESET} {N}_{symb}^{CORESET}$$

is the number of REGs in the CORESET.
For interleaved CCE-to-REG mapping, L∈{2,6} for

$${N}_{symb}^{CORESET} = 1 and L ∈ \{ {N}_{symb}^{CORESET} , 6 \} for {N}_{symb}^{CORESET} ∈ \{ 2 , 3 \} .$$

The interleaver is defined by

$$f ( x ) = ( rC + c + {n}_{shift} ) mod ( {N}_{REG}^{CORESET} / L )$$

$$x = cR + r$$

$$r = 0 , 1 , … , R - 1$$

$$c = 0 , 1 , … , C - 1$$

$$C = {N}_{REG}^{CORESET} / ( LR )$$

Another important aspect to consider is that there is a close connection between the location in frequency of CORESET 0 and SSB, since CORESET 0 has an offset (i.e., “Offset (RBs)”) defined with respect to “Kssb offset” that in turn uses SSB as reference as illustrated in FIG. 2.

The puncturing on PDCCH in CORESET 0 will be determined by the puncturing applied on SSB, and the offset parameters “kssb” and “Offset (RBs)”.

### 4) PUCCH

PUCCH in NR prior to Rel-18 supports multiple formats (i.e., 0, 1, 2, 3, and 4), for which the frequency-domain utilization is either 1 PRB or “1 . . . 16” depending on the format (see 3GPP TS 38.211 and 3GPP TS 38.331). The flexibility of the PUCCH configurations in the frequency-domain suggest that in principle “spectrum allocations from approximately 3 MHz up to below 5 MHz” can be supported with no impact on PUCCH.

### 5) PRACH

To support “spectrum allocations from approximately 3 MHz up to below 5 MHz,” if according to the WID's guideline SCS is to be 15 KHz for PRACH, then PRACH preamble formats in Table 6.3.3.1-2 of TS 38.211 apply (see 3GPP TS 38.211).

Moreover, there is a relationship between PRACH and PUSCH which is given in Table 6.3.3.2-1. If the SCS for both PRACH and PUSCH is to be 15 KHz, then in principle only one entry in Table 6.3.3.2-1 of TS 38.211 is to be considered, and in that case, puncturing is not foreseen to be needed.

### 6) CSI-RS

The Information Element (IE) CSI-FrequencyOccupation is used to configure the frequency domain occupation of a channel state information measurement resource (e.g. NZP-CSI-RS-Resource, CSI-IM-Resource) (see 3GPP TS 38.331). The following descriptions can be highlighted:
nrofRBs: Number of Physical Resource Blocks (PRBs) across which this CSI resource spans. Only multiples of 4 are allowed. The smallest configurable number is the minimum of 24 and the width of the associated bandwidth part (BWP). If the configured value is larger than the width of the corresponding BWP, the UE shall assume that the actual CSI-RS bandwidth is equal to the width of the BWP.
startingRB: PRB where this CSI resource starts in relation to common resource block #0 (CRB #0) on the common resource block grid. Only multiples of 4 are allowed (0, 4, . . . ).

For CSI-RS/TRS, no puncturing is foreseen to be needed. Depending on the decisions to be taken in RAN4 on how many RBs will compose a bandwidth that “is less than 5 MHz,” the “CSI-FrequencyOccupation” can be updated accordingly to maintain the same degree of flexibility.

### SUMMARY

Systems and methods are disclosed for early indication or inference of a narrow channel bandwidth in a wireless network. In one embodiment, a method performed by a User Equipment (UE) in a wireless network comprises determining, based on an explicit or implicit early indication or implicit inference, that the UE is to operate in accordance with a narrow channel bandwidth. The method further comprises operating in accordance with a result of the determining. In this manner, UEs designed to operate in larger bandwidths can make sue of the early indication/inference for decoding purposes, thereby improving performance.

In one embodiment, the narrow channel bandwidth is a channel bandwidth in which one or more channels or signals transmitted on an associated cell are punctured as a result of a bandwidth of the one or more channels or signals exceeding the narrow channel bandwidth. In one embodiment, the one or more channels or signals comprise a Physical Broadcast Channel (PBCH) and/or a Physical Downlink Control Channel (PDCCH) on a Control Resource Set (COREST) configured and used for initial access.

In one embodiment, the wireless network is a New Radio (NR) radio access network, and the narrow channel bandwidth is a NR narrow channel bandwidth. In one embodiment, the narrow channel bandwidth is in a range of and including 3 Megahertz (MHz) to 5 MHz.

In one embodiment, the explicit or implicit early indication or implicit inference is during initial access.

In one embodiment, determining that the UE is to operate in accordance with the narrow channel bandwidth comprises determining that that the UE is to operate in accordance with the narrow channel bandwidth based on an explicit early indication. In one embodiment, the method further comprises receiving the explicit early indication from a network node during initial access. In one embodiment, the explicit early indication is a dedicated synch raster for narrow channel bandwidth. In one embodiment, the explicit early indication is a Global Synchronization Channel Number (GSCN) that is mapped, via a predefined mapping, to the narrow channel bandwidth. In one embodiment, the explicit early indication is a Synchronization Signal Block (SSB) frequency position that is mapped, via a predefined mapping, to the narrow channel bandwidth. In one embodiment, the explicit early indication is a Cell identity (ID) derived from a detected Primary Synchronization Signal (PSS) and Secondary Synchronization Signal (SSS), where the Cell ID is one of a predefined set of Cells IDs associated to narrow channel bandwidths. In one embodiment, the explicit early indication is a Cell ID derived from a detected PSS/SSS, where the Cell ID is mapped, via a predefined mapping, to the narrow channel bandwidth. In one embodiment, the explicit early indication is a detected Demodulation Reference Signal (DMRS) sequence. In one embodiment, the explicit early indication is a scrambling sequence used to scramble a specific part of a detected DMRS sequence used for a PBCH.

In one embodiment, determining that the UE is to operate in accordance with the narrow channel bandwidth comprises determining that that the UE is to operate in accordance with the narrow channel bandwidth based on an implicit early indication. In one embodiment, the method further comprises receiving the implicit early indication from a network node during initial access. In one embodiment, the implicit early indication is operation of the UE in a specific frequency band. In one embodiment, the implicit early indication is obtained by attempting to detect or receive a SSB or a PDCCH in a CORESET #0 with two different hypotheses, one in which the SSB or PDCCH is punctured and another in which the SSB or PDCCH is not punctured. In one embodiment, the implicit early indication is a pre-configuration that the UE is to always operate in a narrow channel bandwidth when the UE operates in a specific frequency band.

In one embodiment, determining that the UE is to operate in accordance with the narrow channel bandwidth comprises determining that that the UE is to operate in accordance with the narrow channel bandwidth based on an implicit early inference. In one embodiment, the implicit early inference is obtained by DMRS estimation for a PBCH using one or more hypotheses in which some symbols are punctured. In one embodiment, the implicit early inference is obtained by DMRS estimation for a PBCH using a first set of one or more hypotheses in which there is no puncturing and a second set of one or more hypotheses in which some symbols are punctured. In one embodiment, the implicit early inference is based on metrics calculated for each of one or more SSB candidates for each of the first and second sets of hypotheses. In one embodiment, the implicit early inference is based on one or more guard bands of an associated transmission bandwidth. In one embodiment, implicit early inference is based received power levels between subsets of resource elements that may be punctured and a subset of resource elements that are not punctured.

Corresponding embodiments of a UE are also disclosed. In one embodiment, a UE is adapted to determine, based on an explicit or implicit early indication or implicit inference, that the UE is to operate in accordance with a narrow channel bandwidth, and operate in accordance with a result of the determining.

In another embodiment, a UE comprises a communication interface comprising a transmitter and a receiver, and processing circuitry associated with the communication interface. The processing circuitry is configured to cause the UE to determine, based on an explicit or implicit early indication or implicit inference, that the UE is to operate in accordance with a narrow channel bandwidth and operate in accordance with a result of the determining.

Embodiments of a method performed by a network node are also disclosed. In one embodiment, a method performed by a network node comprises transmitting to a UE an explicit or implicit early indication that the UE is to operate in accordance with a narrow channel bandwidth.

Corresponding embodiments of a network node are also disclosed. In one embodiment, a network node is adapted to transmit to a UE an explicit or implicit early indication that the UE is to operate in accordance with a narrow channel bandwidth.

In another embodiment, a network node comprises processing circuitry configured to cause the network node to transmit to a UE an explicit or implicit early indication that the UE is to operate in accordance with a narrow channel bandwidth.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the structure of a Synchronization Signal Block (SBB) as defined in 3rd Generation Partnership Project (3GPP) New Radio (NR) specifications;

FIG. 2 illustrates the connection between the location in frequency of Control Resource Set (CORESET) #0 and SSB;

FIG. 3 illustrates a Physical Broadcast Channel (PBCH) transmission;

FIG. 4 illustrates coexistence of Future Railway Mobile Communication System (FRMCS) and Global System for Mobile communications-Railway (GSM-R);

FIG. 5 illustrates the operation of a User Equipment (UE) for early indication/inference of a narrow channel bandwidth, in accordance embodiments of the present disclosure;

FIG. 6 illustrates the operation of a network node for early indication of a narrow channel bandwidth, in accordance embodiments of the present disclosure;

FIG. 7 shows an example of a communication system in accordance with some embodiments;

FIG. 8 shows a UE in accordance with some embodiments;

FIG. 9 shows a network node in accordance with some embodiments;

FIG. 10 is a block diagram of a host, which may be an embodiment of the host of FIG. 7, in accordance with various aspects described herein;

FIG. 11 is a block diagram illustrating a virtualization environment in which functions implemented by some embodiments may be virtualized; and

FIG. 12 shows a communication diagram of a host communicating via a network node with a UE over a partially wireless connection in accordance with some embodiments.

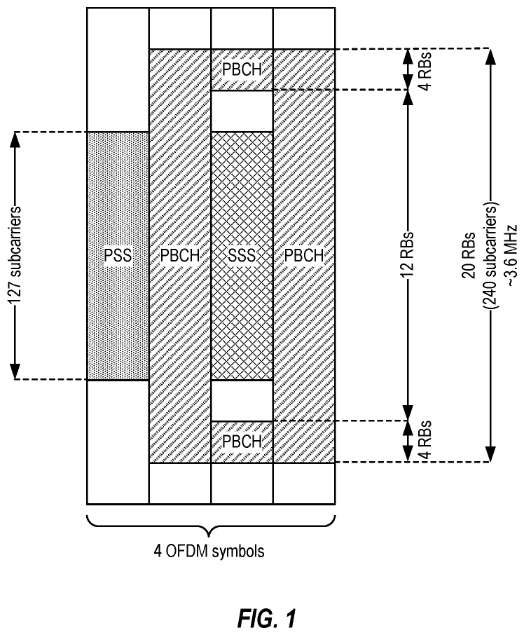

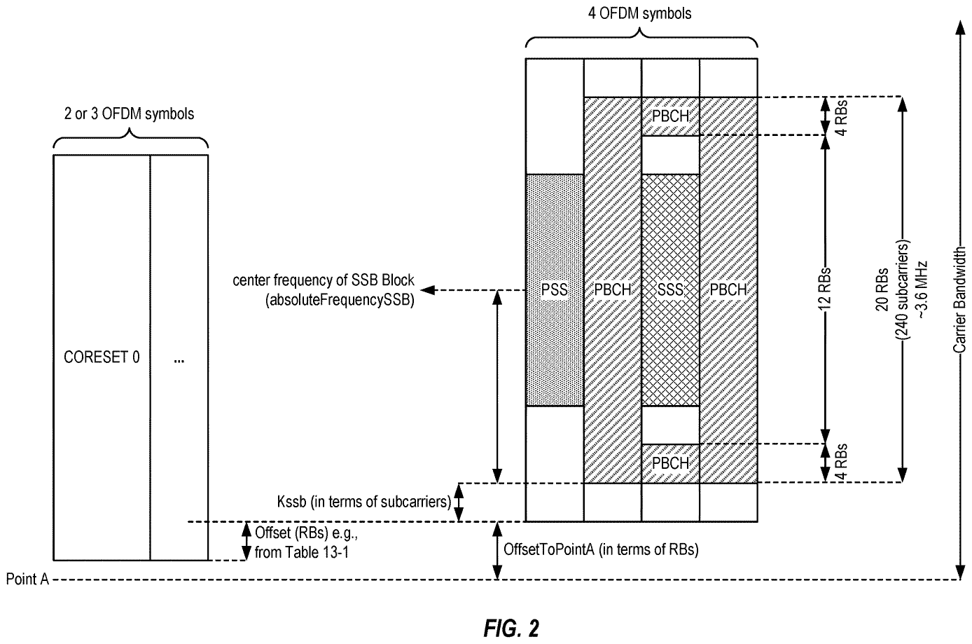

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). According with the initial assessment on the physical channels mentioned in the Work Item Description (WID) for the Work Item (WI) on “NR support for dedicated spectrum less than 5 MHz for FRI” (see RP-213603), some of the physical channels will require to be punctured as to “operate in spectrum allocations from approximately 3 MHz up to below 5 MHz”. One problem is that the User Equipment (UE) may be unaware about the puncturing performed at the transmitter side at the initial access to the band where allocated spectrum is below 5 Megahertz (MHz), which may result in a performance degradation when the UE receives a signal as if this signal were not punctured.

Certain aspects of the disclosure and their embodiments may provide solutions to these or other challenges. Systems and methods are disclosed herein to early indicate/infer a narrow channel bandwidth operation (e.g., a New Radio (NR) narrow channel bandwidth operation). Note that, in the following description, the focus is on NR and a NR narrow channel bandwidth. However, the embodiments described herein are not limited to NR or a NR narrow channel bandwidth. Rather, the embodiments described herein may be utilized other types of similar wireless networks such as, e.g., a 3^{rd} Generation Partnership Project (3GPP) 6^{th} Generation (6G) network.

In one embodiment, the “early indication” or “early inference” of operating in an NR narrow channel bandwidth includes any one or more of the following types of indications or inferences:
Explicit Early Indications (or network-assisted method)
   In one embodiment, the explicit early indication is a dedicated synch raster for NR narrow channel bandwidths (e.g., 3 MHz).
   In another embodiment, the explicit early indication is a Cell Identity (ID) partition, where a set of Cell IDs are associated to NR narrow channel bandwidths (e.g., 3 MHz).
Implicit Early Indications
   In one embodiment, the implicit early indication is as follows: a NR UE operating in a specific band can implicitly assume that it may have to operate in a narrow channel bandwidth running a decoding hypothesis for small and large bandwidth as to derive a conclusion about it.
Implicit Early Inferences
   In one embodiment, the implicit early inference is a Demodulation Reference Signal (DMRS)-based hypothesis. The UE tests the DMRS sequence detection with and/or without a puncturing assumption as to derive conclusions on the NR channel bandwidth.
   In one embodiment, the implicit early inference is a guard band-based hypothesis. The introduction of an “NR narrow channel bandwidth operation” is expected to include the definition of the “Transmission bandwidth” and its corresponding “Guard bands”. Having “guard bands” at both ends of the “transmission bandwidth” can be used by the UE to derive conclusions about the operation in an “NR narrow channel bandwidth”.

Certain embodiments may provide one or more of the following technical advantage(s). Embodiments of the present disclosure may provide any one or more of the following advantages:
If it were possible to early indicate an NR narrow channel bandwidth operation, then UEs that were originally designed to operate in larger bandwidths can make use of such “Early indication” for decoding purposes, which is expected to improve the performance.
The explicit/implicit indications and the implicit inferring about operating in an NR narrow channel bandwidth are timely with respect to any possible indication provided at a later stage e.g., via Master Information Block (MIB) or System Information Block 1 (SIB 1).
Explicit Early Indications:
   The UE will follow a procedure in the technical specifications, hence the gains from the Early indication (in terms of performance) should be overall observable regardless of the UE manufacturer.
   Save UE battery life compared with implicit method because of no hypothetical testing.
Implicit Early Indications:
   No specification impacts. The UE will not follow any procedure in the technical specifications, since an NR UE operating in a specific band can implicitly assume that it may have to operate in a narrow channel bandwidth running a decoding hypothesis for small and large bandwidth as to derive a conclusion about it.
Implicit Early Inferences:
   No specification impacts. The UE will not follow any procedure in the technical specifications, hence taking advantage of essential elements needed for NR narrow channel bandwidth operation (e.g., DMRS, guard bands) the UE can in a proprietary manner (i.e., implementation dependent) derive hypothesis and conclusions about it is operating in an NR channel bandwidth.

Systems and methods are disclosed herein to early indicate or infer an NR narrow channel bandwidth operation. Again, note that while the description herein focuses on NR as a preferred embodiment, the present disclosure is not limited to and may, e.g., be used in future 3GPP radio access technologies (e.g., 6G). The embodiments disclosed herein are categorized as “Explicit Early Indications”, “Implicit Early Indications”, and “Implicit Early Inferences” and are described below in sections 1, 2, and 3 respectively.

In NR narrow channel bandwidth operation, transmission of Synchronization Signal Block (SSB) and Physical Downlink Control Channel (PDCCH) in Control Resource Set (CORESET) #0 may be subject to puncturing or new configurations. The knowledge of these early indication or early inference will allow the UE during initial cell search to properly receive SSB and PDCCH in CORESET #0 in NR narrow channel bandwidth operation.

### 1 Explicit Early Indications

### 1.1 Dedicated Synch Raster for NR Narrow Channel Bandwidths (e.g., 3 MHz).

Synchronization raster is given by Global Synchronization Channel Number (GSCN). The frequency position of the SSB is defined as SS_{REF} with corresponding number GSCN. According to 3GPP TS 38.101-1 Clause 5.4.3.1, the range of GSCN for carrier frequency below 3 Gigahertz (GHz) is from 2 to 7498, The mapping between GSCN and SSB frequency position is given as follows:

$${SS}_{REF} := N * 1200 kHz + M * 50 kHz , N = 1 …2499 , M ∈ \{ 1 , 3 , 5 \}$$

$$GSCN := 3 N + ( M - 3 ) / 2$$

For example, if the SSB frequency position is set to 921.75 MHz, N=767 and M=3, then the corresponding GSCN is given by 3*767+(3−3)/2=2304.

In one embodiment, the channel bandwidth and GSCN are mapped. For example, as shown in Table 2, for NR band n100 (candidate of NR bands used for Future Railway Mobile Communication System (FRMCS)), the range of GSCN is 2303 to 2307. From this range, 2303 and 2306 are mapped to the channel bandwidth of 3 MHz, and 2304, 2305, and 2307 are mapped to the channel bandwidth of 5 MHz. This means, for example, if a UE finds SSB corresponding to GSCN=2303 or 2306, the UE assumes the channel bandwidth is 3 MHz and therefore the UE assumes that some channels (e.g., a predefined set of channels such as, e.g., PBCH) are punctured.

TABLE 2
Example of mapping GSCN and channel bandwidth for band
n100 (Downlink: frequency range: 919.4-925 MHz)

| N | M | SS_{REF} (MHz) | GSCN | Channel bandwidth (MHz) |
|---|---|---|---|---|
| 768 | 1 | 921.65 | 2303 | 3 MHz |
| 768 | 3 | 921.75 | 2304 | 5 MHz |
| 768 | 5 | 921.85 | 2305 | 5 MHz |
| 769 | 1 | 922.85 | 2306 | 3 MHz |
| 769 | 3 | 922.95 | 2307 | 5 MHz |

In another embodiment, new SS_{REF} values different from the existing ones are introduced for an NR band to be used for the narrow channel bandwidth (less than 5 MHz), and when the UE searches for SSB corresponding to these new SS_{REF} values, it assumes that the channel bandwidth is the narrow bandwidth less than 5 MHz (e.g., 3 MHz) and assumes that some channels, e.g., PBCH and PDCCH in CORESET #0 are punctured. See the example in Table 3.

TABLE 3
Example of mapping SS_{REF} and channel bandwidth
for band n100 (Downlink: frequency range: 919.4-925
MHz) where new SS_{REF} values derived by applying an
offset to the existing SS_{REF} values are introduced
for the narrow channel bandwidth of 3 MHz.

| N | M | SS_{REF} (MHz) | GSCN | Channel bandwidth (MHz) |
|---|---|---|---|---|
| 768 | 1 | 921.65 | 2303 | 5 MHz |
| 768* | 1* | 921.65 + Δ | 2303* | 3 MHz |
| 768 | 3 | 921.75 | 2304 | 5 MHz |
| 768* | 3* | 921.75 + Δ | 2304* | 3 MHz |
| 768 | 5 | 921.85 | 2305 | 5 MHz |
| 768* | 5* | 921.85 + Δ | 2305* | 3 MHz |
| 769 | 1 | 922.85 | 2306 | 5 MHz |
| 769* | 1* | 922.85 + Δ | 2306* | 3 MHz |
| 769 | 3 | 922.95 | 2307 | 5 MHz |
| 769* | 3* | 922.95 + Δ | 2307* | 3 MHz |

Note that the mapping from N and M to the corresponding GSCN and SS_{REF} values shown in Table 3 is an example where for each M and N, there are two SS_{REF} values, one determined from SS_{REF}=N*1200 kHz+M*50 kHz and another from SS_{REF}=N*1200 kHz+M*50 KHz+4. The value of Δ can be set to e.g., 540 kHz. In general, it may be any value larger than 50 kHz but less than 1200 kHz.

1.2 Cell ID Partition, where a Set of Cell IDs are Associated to NR Narrow Channel Bandwidths (e.g., 3 MHz).

At initial access, the UE searches for PSS/SSS signals included in SSB. The sequences of PSS and SSS are derived from Cell ID (N_{Cell}). According to 3GPP TS 38.211 Clause 7.4.2, there are 1008 Cell IDs configured by the network and given by:

$${N}_{Cell} := 3 * {N}_{1} + {N}_{2} ,$$

where PSS sequence is derived from N₂, and its range is {0, 1, 2}. SSS sequence is derived from N₁ and its range is {0, 1, . . . , 335}.

In one embodiment, the cell ID is mapped to the channel bandwidth in the frequency band where the channel bandwidth is 3 MHz or 5 MHz.

For example, as shown in Table 4, if the channel bandwidth is 3 MHz, the NR base station (gNodeB, gNB) configures N₂=0, and if the channel bandwidth is 5 MHz, gNB configures N₂₌₁ or 2.

Another example is, as shown in Table 5, the gNB configures N₁=0 to 99 for the case the channel bandwidth is 3 MHz and N₁=100 to 335 in the case the channel bandwidth is 5 MHz.

TABLE 4
Example of mapping Cell ID and channel
bandwidth for band n100.

| | | | Channel |
|---|---|---|---|
| | | | bandwidth |
| N₁ {0, 1, . . . , 335} | N₂ {0, 1, 2} | Cell ID | (MHz) |
| 0, 1, . . . , 335 | 0 | 0, 3, . . . , 1002, 1005 | 3 MHz |
| 0, 1, . . . , 335 | 1, 2 | 1, 2, 4, 5, . . . , 1003, | 5 MHz |
| | | 1004, 1006, 1007 | |

TABLE 5
Another example of mapping Cell ID and
channel bandwidth for band n100.

| | | | Channel |
|---|---|---|---|
| | | | bandwidth |
| N₁ {0, 1, . . . , 335} | N₂ {0, 1, 2} | Cell ID | (MHz) |
| 0, . . . , 99 | 0, 1, 2 | 0, 1, . . . , 297, 298, 299 | 3 MHz |
| 100, . . . , 335 | 0, 1, 2 | 300, 301, . . . , 1005, | 5 MHz |
| | | 1006, 1007 | |

### 1.3 Indication Through New DMRS Sequences of PBCH

In NR operation with narrow channel bandwidth less than 5 MHz, it is understood from the design guidelines that PSS and SSS will not be punctured. This implies that the part of Physical Broadcast Channel (PBCH) with subcarrier indices overlapping with those of PSS/SSS will not be punctured either.

In one embodiment, new DMRS sequences of smaller size are introduced for PBCH transmission in NR operation with narrow channel bandwidth less than 5 MHz. When PBCH is transmitted over narrow channel bandwidth resulting in some PBCH subcarriers being punctured, the new DMRS sequence(s) will be used and mapped onto resource elements which are contained within the non-punctured region in the narrow channel bandwidth.

In a related embodiment, different new DMRS sequences can be generated by applying different cyclic shifts to a new DMRS base sequence. Different DMRS sequences can be used to carry early indication information related to the narrow channel bandwidth and/or which subcarriers of PBCH are punctured. For example, 4 different sequences carry 2 bits of information that can be used for an early indication. As an example, for illustration purposes 2 bits can be use as follows:
00: A RB bottom, B RB top,
01: C RB bottom, D RB top,
10: E RB bottom, F RB top,
11: G RB bottom, H RB top,
   where A, B, C, D, E, F, G, H refer to integer numbers which can be the same or different.

In another embodiment, a scrambling sequence is used to scramble a specific part of DMRS sequence used for PBCH to provide an early indication of the narrow channel bandwidth. One example of the specific part to which the scrambling sequence is applied is the part which is mapped onto the resource element(s) overlapping with PSS and SSS. Upon receiving the PBCH, the UE can attempt to check whether the specific part of the DMRS was scrambled and, if so, obtain the early indication of the narrow channel bandwidth.

### 2 Implicit Early Indications

### 2.1 Implicit Indication per Band

In one embodiment, an NR UE operating in a specific band implicitly assumes that it may have to operate in a narrow channel bandwidth. That is, the UE during initial cell search in the specific band assumes that transmissions of SSB and PDCCH in CORESET #0 (e.g., PDCCH scheduling SIB1) can be subject to puncturing due to narrow channel bandwidth. For example, the UE may attempt to detect/receive an SSB or a PDCCH in CORESET #0 with two different hypotheses that SSB or PDCCH may or may not be punctured to fit within the narrow channel bandwidth.

In a related embodiment, in a specific deployment, an NR UE operating in a specific band can be pre-configured to always operate in the narrow channel bandwidth operation.

### 3 Implicit Early Inferences

### 3.1 DMRS-Based Hypothesis

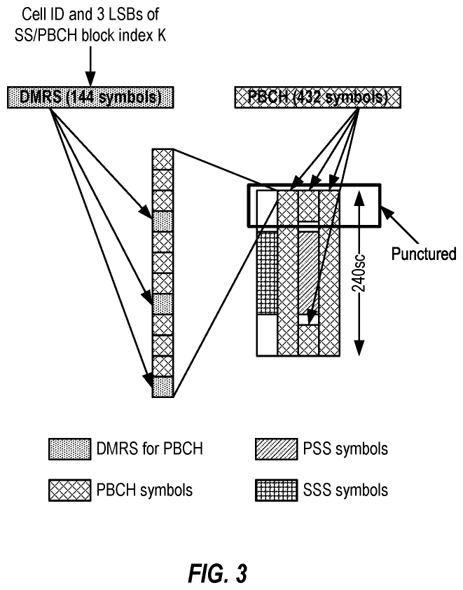

At the initial access, after Cell ID acquisition, the UE needs to acquire MIB from PBCH. To decode PBCH, the UE first needs to perform channel estimation from PBCH DMRS which is transmitted every 4 subcarriers as shown in FIG. 3. To perform the channel estimation, the UE need to know the PBCH DMRS sequence, and it is derived from Cell ID and SSB index. According to 3GPP TS38.213 Clause 4.1, there are 4 SSB index candidates in frequency range 1 (FR1) below 3 GHz. At the initial access, before PBCH decoding, since the UE only knows the Cell ID, the UE need to detect the SSB index by hypothetical testing.

If the UE assumes PBCH (and PBCH DMRS) is transmitted without puncturing, the UE detects SSB index k by hypothetical testing.

One example of DMRS estimation process is as follows:

Consider the received DMRS symbols in the SS/PBCH block is g(i), i∈R_{non-puncturing}, and used DMRS sequence with time index k is pₖ(i), where R_{non-puncturing} is the set of DMRS symbols without puncturing. The UE generates the candidate DMRS sequences PK (i), k E Q, where Q is the set of time index candidates. For example, in the case of FR1 below 3 GHz assumed for FRMCS, Q={0, 1, 2, 3}.

The UE calculates the metric for each candidate k∈Q:

$${h}_{k} ( i ) = {p}_{k}^{*} ( i ) \cdot g ( i )$$

$${m}_{{k}_{non - puncturing}} = \frac{1}{{N}_{non - puncturing}} {\sum }_{i ∈ {R}_{non - puncturing}} {\vert {h}_{k} ( i ) \vert}^{2}$$

N_{non-puncturing} is the number of DMRS symbols in R_{non-puncturing}.

The UE decides the SSB index k which maximizes the metric:

$${SSB}_{index} = arg max ( {m}_{{k}_{non - puncturing}} )$$

If there is the possibility PBCH is punctured, the UE also perform hypothetical testing assuming some symbols are punctured. Consider the received DMRS symbols in the punctured SS/PBCH block is g(i), i∈R_{puncturing}, and used DMRS sequence with time index k is pₖ(i), where R_{puncturing} is the set of DMRS symbols with puncturing. The UE generates the candidate DMRS sequences pₖ(i), k∈Q, where Q is the set of time index candidates.

The UE calculates the metric for each candidate k∈Q:

$${h}_{k} ( i ) = {p}_{k}^{*} ( i ) \cdot g ( i )$$

$${m}_{{k}_{puncturing}} = \frac{1}{{N}_{puncturing}} {\sum }_{i ∈ {R}_{puncturing}} {\vert {h}_{k} ( i ) \vert}^{2}$$

N_{puncturing} is the number of DMRS symbols in R_{puncturing}.

The UE decides the SSB index k from:

$${SSB}_{index} = arg max ( {m}_{{k}_{non - puncturing}} , {m}_{{k}_{puncturing}} )$$

If the SSB index is chosen from mₖ_{_{non-puncturing}}, the UE assumes SSB index not punctured. If the SSB index is chosen from mₖ_{_{puncturing}}, the UE assumes SSB index is punctured.

FIG. 3 illustrates a PBCH transmission.

### 3.2 Guard Band-Based Hypothesis

For supporting “spectrum allocations from approximately 3 MHz up to below 5 MHz,” (e.g., a 3 MHz channel bandwidth), it is foreseen that the “Maximum transmission bandwidth configuration” and the “Minimum guard band” will need to be recalculated and specified by 3GPP RAN4 working group.

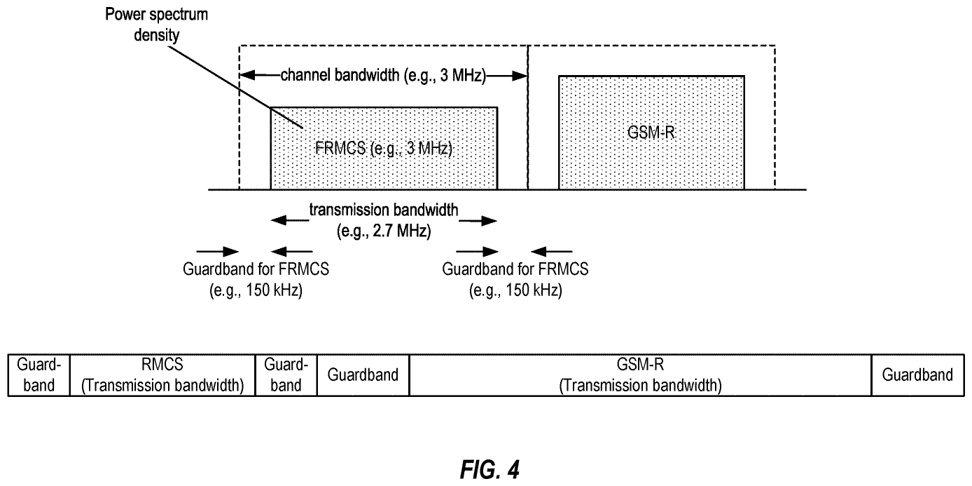

Once the “Maximum transmission bandwidth configuration” and “Minimum guard band” are specified, the co-existence of e.g., FRMCS with Global System for Mobile communications—Railway (GSM-R) can overall be visualized as shown in FIG. 4. In this example, it is assumed the transmission bandwidth of FRMCS is 2.7 MHz and the guardband of 150 kHz for each side.

The guard bands on their own could be used as a way of knowing about the reduced bandwidth. For example, the UE can derive conclusions about the NR narrow channel bandwidth operation upon just detecting noise outside the transmission bandwidth.

Although for an NR narrow channel bandwidth operation the guard bands may consist of few hundreds of kHz, the fact of having symmetric guard bands at both the lower and upper boundaries of the transmission bandwidth can be used by the UE to derive conclusions about the NR narrow channel bandwidth operation.

### 3.3 PBCH Block Resource Elements Based Hypothesis Testing

It is stated in 3GPP TS 38.213 Sec. 4.1 that the UE assumes that SSS, PBCH DM-RS, and PBCH data have same Energy Per Resource Element (EPRE).

The punctured resource elements will not be transmitted by the network with NR operation in narrow bandwidth. It is known that the resource element locations containing the SSS are not to be punctured, Table 2. The UE knows that the possible punctured resource element locations will lie in either the first 48 subcarriers or last 48 subcarriers or in both and in the last 3 OFDM symbols of the SSB. The punctured resource elements can be both PBCH DM-RS and PBCH payload data.

An example hypothesis test could be to compare the received power levels between subsets of resource elements that may be punctured and a subset of resource elements that are not punctured containing SSS, PBCH DM-RS and PBCH data. Based on this test/comparison, the UE determines whether to assume puncturing or no puncturing and operations accordingly.

### 4 Further Description

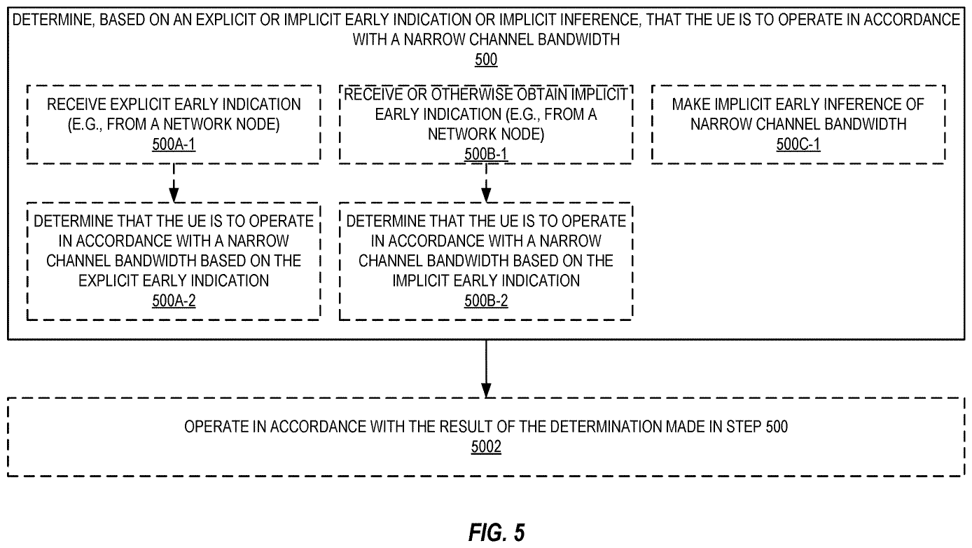

FIG. 5 illustrates the operation of a UE in accordance with at least some of the embodiments described above in Sections 1, 2, and 3. Thus, not at details of the embodiments described in Sections 1, 2, and 3 above are repeated here; however, it is to be understood that those details are applicable to the process of FIG. 5. Optional steps are represented by dashed lines/boxes. As illustrated, at or during initial access (e.g., to a cell), the UE determines, based on an explicit early indication, an implicit early indication, or an implicit early inference, that the UE is to operate in accordance with a NR narrow channel bandwidth (e.g., a bandwidth that is in the range of and including 3 MHz to 5 MHz) (step 500).

More specifically, in one embodiment, the UE receives, from a network node (e.g., a base station such as, e.g., a gNB), an explicit early indication of (e.g., NR) narrow channel bandwidth operation (step 500A-1). This explicit early indication may be in accordance with any of the embodiments described in Section 1 above. The UE determines that it is to operate in accordance with a NR narrow channel bandwidth based on the received explicit early indication (step 500A-2).

In another embodiment, the UE receives (e.g., from a network node) or otherwise obtains an implicit early indication of (e.g., NR) narrow channel bandwidth operation (step 500B-1). This implicit early indication may be in accordance with any of the embodiments described in Section 2 above. The UE determines that it is to operate in accordance with a NR narrow channel bandwidth based on the received implicit early indication (step 500B-2).

In another embodiment, the UE makes an implicit early inference of narrow channel bandwidth operation (step 500C-1). This implicit early inference may be in accordance with any of the embodiments described in Section 3 above. The UE determines that it is to operate in accordance with a NR narrow channel bandwidth based on the implicit early inference (step 500C-2).

The UE then operates in accordance with the determination made in step 500 (step 502). For example, upon determining that it should operate in accordance with (e.g., NR) narrow channel bandwidth operation, the UE operates based on an assumption that a predefined set of one or more physical channels (e.g., SSB) are punctured.

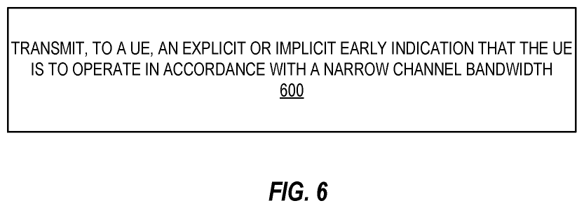

FIG. 6 illustrates the operation of a network node (e.g., a base station such as, e.g., a gNB) in accordance with at least some of the embodiments described above. Thus, not at details of the embodiments described above are repeated here; however, it is to be understood that those details are applicable to the process of FIG. 6. As illustrated, at or during initial access (e.g., to a cell), the network node transmits, to the UE, an explicit or implicit early indication that the UE is to operate in accordance with a NR narrow channel bandwidth (e.g., a bandwidth that is in the range of and including 3 MHz to 5 MHz) (step 600). The explicit or implicit indication may be in accordance with any of the embodiments described in Sections 1 or 2 above in which the network node is involved.

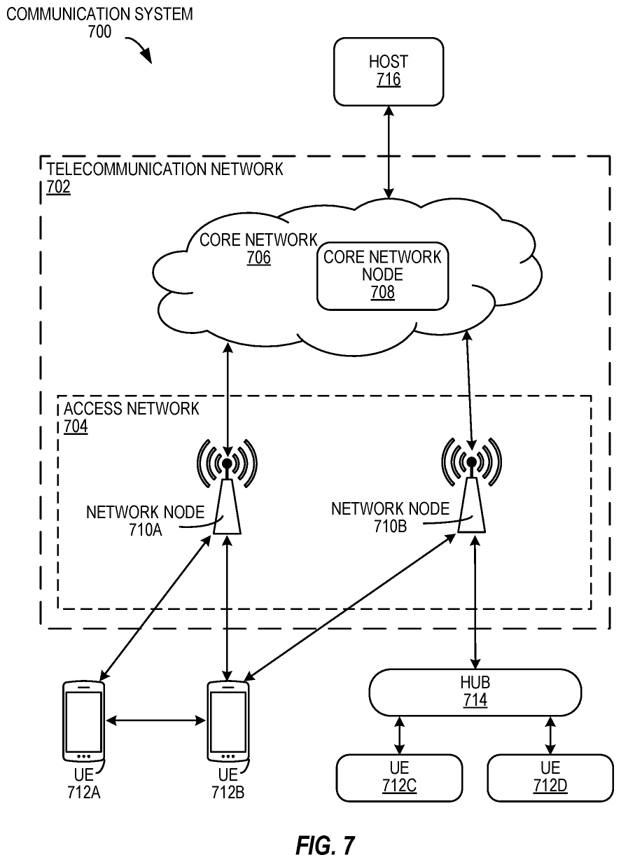

FIG. 7 shows an example of a communication system 700 in accordance with some embodiments.

In the example, the communication system 700 includes a telecommunication network 702 that includes an access network 704, such as a Radio Access Network (RAN), and a core network 706, which includes one or more core network nodes 708. The access network 704 includes one or more access network nodes, such as network nodes 710A and 710B (one or more of which may be generally referred to as network nodes 710), or any other similar Third Generation Partnership Project (3GPP) access node or non-3GPP Access Point (AP). The network nodes 710 facilitate direct or indirect connection of User Equipment (UE), such as by connecting UEs 712A, 712B, 712C, and 712D (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system 700 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 702 is a cellular network that implements 3GPP standardized features. Accordingly, the telecommunication network 702 may support network slicing to provide different logical networks to different devices that are connected to the telecommunication network 702. For example, the telecommunication network 702 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR—Dual Connectivity (EN-DC).

In the example, a hub 714 communicates with the access network 704 to facilitate indirect communication between one or more UEs (e.g., UE 712C and/or 712D) and network nodes (e.g., network node 710B). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a Virtual Reality (VR) headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710B. The hub 714 may also allow for a different communication scheme and/or schedule between the hub 714 and UEs (e.g., UE 712C and/or 712D), and between the hub 714 and the core network 706. In other examples, the hub 714 is connected to the core network 706 and/or one or more UEs via a wired connection. Moreover, the hub 714 may be configured to connect to a Machine-to-Machine (M2M) service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710B. In other embodiments, the hub 714 may be a non-dedicated hub—that is, a device which is capable of operating to route communications between the UEs and the network node 710B, but which is additionally capable of operating as a communication start and/or end point for certain data channels.

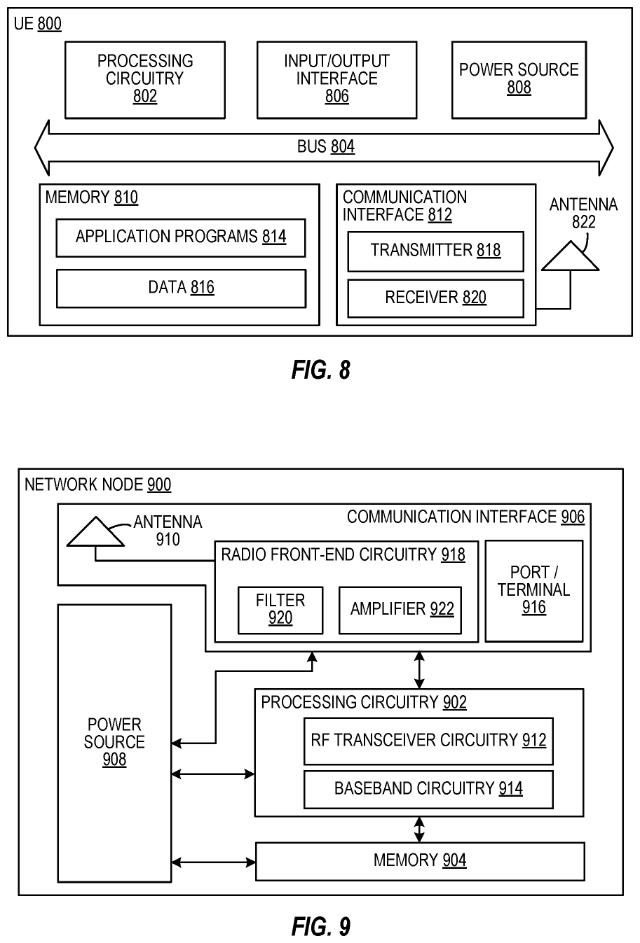

FIG. 8 shows a UE 800 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 802 may include multiple Central Processing Units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging the power source 808. Power circuitry may perform any formatting, converting, or other modification to the power from the power source 808 to make the power suitable for the respective components of the UE 800 to which power is supplied.

The memory 810 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 810 may allow the UE 800 to access instructions, application programs, and the like stored on transitory or non-transitory memory media, to off-load data, or to upload data. An article of manufacture, such as one utilizing a communication system, may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., the antenna 822) and may share circuit components, software, or firmware, or alternatively be implemented separately.

In the illustrated embodiment, communication functions of the communication interface 812 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 812, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 9 shows a network node 900 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes processing circuitry 902, memory 904, a communication interface 906, and a power source 908. The network node 900 may be composed of multiple physically separate components (e.g., a Node B component and an RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 900 may be configured to support multiple RATs. In such embodiments, some components may be duplicated (e.g., separate memory 904 for different RATs) and some components may be reused (e.g., an antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 900.

The processing circuitry 902 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 900 components, such as the memory 904, to provide network node 900 functionality.

In some embodiments, the processing circuitry 902 includes a System on a Chip (SOC). In some embodiments, the processing circuitry 902 includes one or more of Radio Frequency (RF) transceiver circuitry 912 and baseband processing circuitry 914. In some embodiments, the RF transceiver circuitry 912 and the baseband processing circuitry 914 may be on separate chips (or sets of chips), boards, or units, such as radio units and digital units. In alternative embodiments, part or all of the RF transceiver circuitry 912 and the baseband processing circuitry 914 may be on the same chip or set of chips, boards, or units.

The memory 904 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and the memory 904 are integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. The radio front-end circuitry 918 comprises filters 920 and amplifiers 922. The radio front-end circuitry 918 may be connected to the antenna 910 and the processing circuitry 902. The radio front-end circuitry 918 may be configured to condition signals communicated between the antenna 910 and the processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of the filters 920 and/or the amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface 906 may comprise different components and/or different combinations of components.

In certain alternative embodiments, the network node 900 does not include separate radio front-end circuitry 918; instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes the one or more ports or terminals 916, the radio front-end circuitry 918, and the RF transceiver circuitry 912 as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, the communication interface 906, and/or the processing circuitry 902 may be configured to perform any receiving operations and/or certain obtaining operations described herein as being performed by the network node 900. Any information, data, and/or signals may be received from a UE, another network node, and/or any other network equipment. Similarly, the antenna 910, the communication interface 906, and/or the processing circuitry 902 may be configured to perform any transmitting operations described herein as being performed by the network node 900. Any information, data, and/or signals may be transmitted to a UE, another network node, and/or any other network equipment.

The power source 908 provides power to the various components of the network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid or an electricity outlet) via input circuitry or an interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

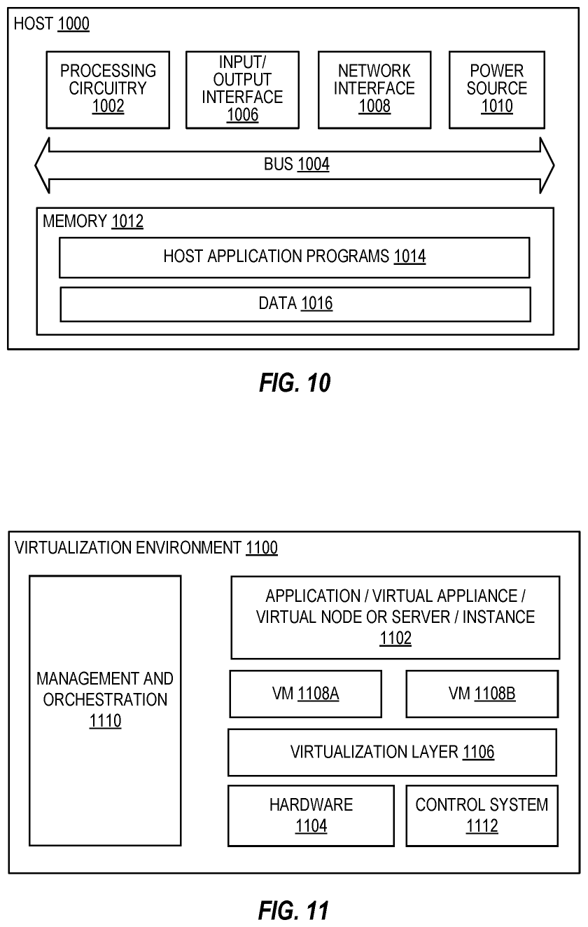

FIG. 10 is a block diagram of a host 1000, which may be an embodiment of the host 716 of FIG. 7, in accordance with various aspects described herein. As used herein, the host 1000 may be or comprise various combinations of hardware and/or software including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and memory 1012. Other components may be included in other embodiments. Features of these components may be substantially similar to those described with respect to the devices of previous figures, such as FIGS. 8 and 9, such that the descriptions thereof are generally applicable to the corresponding components of the host 1000.

The memory 1012 may include one or more computer programs including one or more host application programs 1014 and data 1016, which may include user data, e.g. data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for Over-The-Top (OTT) services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1102 (which may alternatively be called software instances, virtual appliances, network functions, virtual nodes, virtual network functions, etc.) are run in the virtualization environment 1000 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or VM Monitors (VMMs)), provide VMs 1108A and 1108B (one or more of which may be generally referred to as VMs 1108), and/or perform any of the functions, features, and/or benefits described in relation with some embodiments described herein. The virtualization layer 1106 may present a virtual operating platform that appears like networking hardware to the VMs 1108.

The VMs 1108 comprise virtual processing, virtual memory, virtual networking, or interface and virtual storage, and may be run by a corresponding virtualization layer 1106. Different embodiments of the instance of a virtual appliance 1102 may be implemented on one or more of the VMs 1108, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1108 may be a software implementation of a physical machine that runs programs as if they were executing on a physical, non-virtualized machine. Each of the VMs 1108, and that part of the hardware 1104 that executes that VM, be it hardware dedicated to that VM and/or hardware shared by that VM with others of the VMs 1108, forms separate virtual network elements. Still in the context of NFV, a virtual network function is responsible for handling specific network functions that run in one or more VMs 1108 on top of the hardware 1104 and corresponds to the application 1102.

The hardware 1104 may be implemented in a standalone network node with generic or specific components. The hardware 1104 may implement some functions via virtualization. Alternatively, the hardware 1104 may be part of a larger cluster of hardware (e.g., such as in a data center or CPE) where many hardware nodes work together and are managed via management and orchestration 1110, which, among others, oversees lifecycle management of the applications 1102. In some embodiments, the hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1112 which may alternatively be used for communication between hardware nodes and radio units.

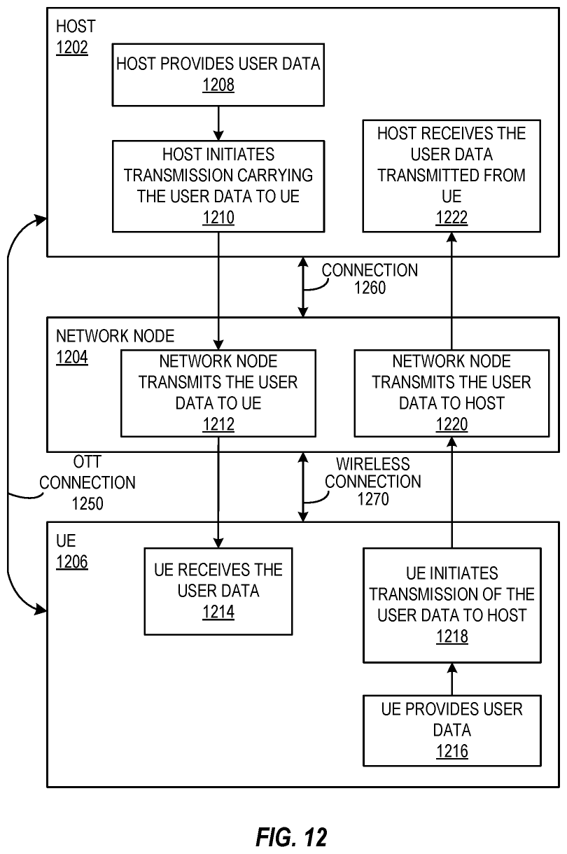

FIG. 12 shows a communication diagram of a host 1202 communicating via a network node 1204 with a UE 1206 over a partially wireless connection in accordance with some embodiments. Example implementations, in accordance with various embodiments, of the UE (such as the UE 712A of FIG. 7 and/or the UE 800 of FIG. 8), the network node (such as the network node 710A of FIG. 7 and/or the network node 900 of FIG. 9), and the host (such as the host 716 of FIG. 7 and/or the host 1000 of FIG. 10) discussed in the preceding paragraphs will now be described with reference to FIG. 12.

Like the host 1000, embodiments of the host 1202 include hardware, such as a communication interface, processing circuitry, and memory. The host 1202 also includes software, which is stored in or is accessible by the host 1202 and executable by the processing circuitry. The software includes a host application that may be operable to provide a service to a remote user, such as the UE 1206 connecting via an OTT connection 1250 extending between the UE 1206 and the host 1202. In providing the service to the remote user, a host application may provide user data which is transmitted using the OTT connection 1250.

The network node 1204 includes hardware enabling it to communicate with the host 1202 and the UE 1206 via a connection 1260. The connection 1260 may be direct or pass through a core network (like the core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by the UE 1206 and executable by the UE's processing circuitry. The software includes a client application, such as a web browser or operator-specific “app” that may be operable to provide a service to a human or non-human user via the UE 1206 with the support of the host 1202. In the host 1202, an executing host application may communicate with the executing client application via the OTT connection 1250 terminating at the UE 1206 and the host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via the connection 1260 between the host 1202 and the network node 1204 and via a wireless connection 1270 between the network node 1204 and the UE 1206 to provide the connection between the host 1202 and the UE 1206. The connection 1260 and the wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204 in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR, or AR which it can broadcast, multicast, or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1250 between the host 1202 and the UE 1206 in response to variations in the measurement results. The measurement procedure and/or the network functionality for reconfiguring the OTT connection 1250 may be implemented in software and hardware of the host 1202 and/or the UE 1206. In some embodiments, sensors (not shown) may be deployed in or in association with other devices through which the OTT connection 1250 passes; the sensors may participate in the measurement procedure by supplying values of the monitored quantities exemplified above, or by supplying values of other physical quantities from which software may compute or estimate the monitored quantities. The reconfiguring of the OTT connection 1250 may include message format, retransmission settings, preferred routing, etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency, and the like by the host 1202. The measurements may be implemented in that software causes messages to be transmitted, in particular empty or ‘dummy’ messages, using the OTT connection 1250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some example embodiments of the present disclosure are as follows:

### Group A Embodiments

Embodiment 1: A method performed by a User Equipment, UE, in a wireless network, the method comprising: determining (500), based on an explicit or implicit early indication or implicit inference, that the UE is to operate in accordance with a narrow channel bandwidth; and operating (502) in accordance with a result of the determining (500).

Embodiment 2: The method of embodiment 1 wherein the wireless network is a New Radio, NR, radio access network, and the narrow channel bandwidth is a NR narrow channel bandwidth.

Embodiment 3: The method of embodiment 2 wherein the narrow channel bandwidth is in a range of and including 3 MHz to 5 MHz.

Embodiment 4: The method of any of embodiments 1 to 3 wherein the explicit or implicit early indication or implicit inference is during initial access.

Embodiment 5: The method of any of embodiments 1 to 4 wherein determining (500) comprises determining (500) that that the UE is to operate in accordance with the narrow channel bandwidth based on an explicit early indication.

Embodiment 6: The method of embodiment 5 further comprising receiving (500A-1) the explicit early indication from a network node during initial access.

Embodiment 7: The method of embodiment 5 or 6 wherein the explicit early indication is a dedicated synch raster for narrow channel bandwidth.

Embodiment 8: The method of embodiment 5 or 6 wherein the explicit early indication is a Global Synchronization Channel Number, GSCN, that is mapped, via a predefined mapping, to the narrow channel bandwidth.

Embodiment 9: The method of embodiment 5 or 6 wherein the explicit early indication is a SS_{REF} value that is mapped, via a predefined mapping, to the narrow channel bandwidth.

Embodiment 10: The method of embodiment 5 or 6 wherein the explicit early indication is Cell ID derived from a detected PSS/SSS where the Cell ID is one of a predefined set of Cells IDs associated to narrow channel bandwidths.

Embodiment 11: The method of embodiment 5 or 6 wherein the explicit early indication is Cell ID derived from a detected PSS/SSS where the Cell ID is mapped, via a predefined mapping, to a narrow channel bandwidth.

Embodiment 12: The method of embodiment 5 or 6 wherein the explicit early indication is DMRS sequence.

Embodiment 13: The method of embodiment 5 or 6 wherein the explicit early indication is a scrambling sequence used to scramble a specific part of a DMRS sequence used for PBCH.

Embodiment 14: The method of any of embodiments 1 to 4 wherein determining (500) comprises determining (500) that that the UE is to operate in accordance with the narrow channel bandwidth based on an implicit early indication.

Embodiment 15: The method of embodiment 14 further comprising receiving (500B-1) the implicit early indication from a network node during initial access.

Embodiment 16: The method of embodiment 14 or 15 wherein the implicit early indication is operation of the UE in a specific frequency band.

Embodiment 17: The method of embodiment 14 or 15 wherein the implicit early indication is obtained by attempting to detect or receive an SSB or PDCCH in CORESET #0 with two different hypotheses, one in which the SSB or PDCCH is punctured and in which the SSB or PDCCH is not punctured.

Embodiment 18: The method of embodiment 14 or 15 wherein the implicit early indication is a pre-configuration that the UE is to always operate in a narrow channel bandwidth when the UE operates in a specific frequency band.

Embodiment 19: The method of any of embodiments 1 to 4 wherein determining (500) comprises determining (500) that that the UE is to operate in accordance with the narrow channel bandwidth based on an implicit early inference.

Embodiment 20: The method of embodiment 19 wherein the implicit early inference is obtained by DMRS estimation for PBCH using one or more hypotheses in which some symbols are punctured.

Embodiment 21: The method of embodiment 19 wherein the implicit early inference is obtained by DMRS estimation for PBCH using a first set of one or more hypotheses in which there is no puncturing and a second set of one or more hypotheses in which some symbols are punctured.

Embodiment 22: The method of embodiment 19 wherein the implicit early inference is based on metrics calculated for each of one or more SSB candidates for each of the first and second sets of hypotheses.

Embodiment 23: The method of embodiment 19 wherein the implicit early inference is based on one or more guard bands of an associated transmission bandwidth.

Embodiment 24: The method of embodiment 19 wherein the implicit early inference is based received power levels between subsets of resource elements that may be punctured and a subset of resource elements that are not punctured (e.g., containing SSS, PBCH DMRS, and PBCH data).

Embodiment 25: The method of any of the previous embodiments, further comprising: providing user data; and forwarding the user data to a host via the transmission to the network node.

### Group B Embodiments

Embodiment 26: A method performed by a network node, the method comprising: transmitting (600), to a UE, an explicit or implicit early indication that the UE is to operate in accordance with a narrow channel bandwidth.

Embodiment 27: The method of embodiment 26 wherein the wireless network is a New Radio, NR, radio access network, and the narrow channel bandwidth is a NR narrow channel bandwidth.

Embodiment 28: The method of embodiment 27 wherein the narrow channel bandwidth is in a range of and including 3 MHz to 5 MHz.

Embodiment 29: The method of any of embodiments 26 to 28 wherein the explicit or implicit early indication is transmitted during initial access of the UE.

Embodiment 30: The method of any of embodiments 26 to 29 wherein explicit or implicit early indication is an explicit early indication.

Embodiment 31: The method of embodiment 30 wherein the explicit early indication is a dedicated synch raster for narrow channel bandwidth.

Embodiment 32: The method of embodiment 30 wherein the explicit early indication is a Global Synchronization Channel Number, GSCN, that is mapped, via a predefined mapping, to the narrow channel bandwidth.

Embodiment 33: The method of embodiment 30 wherein the explicit early indication is a SS_{REF} value that is mapped, via a predefined mapping, to the narrow channel bandwidth.

Embodiment 34: The method of embodiment 30 wherein the explicit early indication is Cell ID derived from a transmitted PSS/SSS where the Cell ID is one of a predefined set of Cells IDs associated to narrow channel bandwidths.

Embodiment 35: The method of embodiment 30 wherein the explicit early indication is Cell ID derived from a transmitted PSS/SSS where the Cell ID is mapped, via a predefined mapping, to a narrow channel bandwidth.

Embodiment 36: The method of embodiment 30 wherein the explicit early indication is DMRS sequence.

Embodiment 37: The method of embodiment 30 wherein the explicit early indication is a scrambling sequence used to scramble a specific part of a DMRS sequence used for PBCH.

Embodiment 38: The method of any of embodiments 26 to 29 wherein explicit or implicit early indication is an implicit early indication.

Embodiment 39: The method of any of the previous embodiments, further comprising: obtaining user data; and forwarding the user data to a host or a user equipment.

### Group C Embodiments

Embodiment 40: A user equipment comprising: processing circuitry configured to perform any of the steps of any of the Group A embodiments; and power supply circuitry configured to supply power to the processing circuitry.

Embodiment 41: A network node comprising: processing circuitry configured to perform any of the steps of any of the Group B embodiments; and power supply circuitry configured to supply power to the processing circuitry.

Embodiment 42: A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 43: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 44: The host of the previous embodiment, wherein the cellular network further includes a network node configured to communicate with the UE to transmit the user data to the UE from the host.

Embodiment 45: The host of the previous 2 embodiments, wherein: the processing circuitry of the host is configured to execute a host application, thereby providing the user data; and the host application is configured to interact with a client application executing on the UE, the client application being associated with the host application.

Embodiment 46: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 47: The method of the previous embodiment, further comprising: at the host, executing a host application associated with a client application executing on the UE to receive the user data from the UE.

Embodiment 48: The method of the previous embodiment, further comprising: at the host, transmitting input data to the client application executing on the UE, the input data being provided by executing the host application, wherein the user data is provided by the client application in response to the input data from the host application.

Embodiment 49: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 50: The host of the previous embodiment, wherein the cellular network further includes a network node configured to communicate with the UE to transmit the user data from the UE to the host.

Embodiment 51: The host of the previous 2 embodiments, wherein: the processing circuitry of the host is configured to execute a host application, thereby providing the user data; and the host application is configured to interact with a client application executing on the UE, the client application being associated with the host application.

Embodiment 52: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 53: The method of the previous embodiment, further comprising: at the host, executing a host application associated with a client application executing on the UE to receive the user data from the UE.

Embodiment 54: The method of the previous embodiment, further comprising: at the host, transmitting input data to the client application executing on the UE, the input data being provided by executing the host application, wherein the user data is provided by the client application in response to the input data from the host application.

Embodiment 55: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 56: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 57: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 58: The method of the previous embodiment, further comprising, at the network node, transmitting the user data provided by the host for the UE.

Embodiment 59: The method of any of the previous 2 embodiments, wherein the user data is provided at the host by executing a host application that interacts with a client application executing on the UE, the client application being associated with the host application.

Embodiment 60: A communication system configured to provide an over-the-top service, the communication system comprising a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 61: The communication system of the previous embodiment, further comprising: the network node; and/or the user equipment.

Embodiment 62: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 63: The host of the previous 2 embodiments, wherein: the processing circuitry of the host is configured to execute a host application, thereby providing the user data; and the host application is configured to interact with a client application executing on the UE, the client application being associated with the host application.

Embodiment 64: The host of the any of the previous 2 embodiments, wherein the initiating receipt of the user data comprises requesting the user data.

Embodiment 65: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 66: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a User Equipment (UE) in a wireless network, the method comprising:
determining, based on an explicit or implicit early indication or implicit inference, that the UE is to operate in accordance with a narrow channel bandwidth, wherein the narrow channel bandwidth is a channel bandwidth in which one or more channels or signals transmitted on an associated cell are punctured as a result of a bandwidth of the one or more channels or signals exceeding the narrow channel bandwidth; and
operating in accordance with a result of the determining.

2. (canceled)

3. The method of claim 1 wherein the one or more channels or signals comprise a Physical Broadcast Channel (PBCH) and/or a Physical Downlink Control Channel (PDCCH) on a Control Resource Set (CORESET) configured and used for initial access.

4. The method of claim 1 wherein the wireless network is a New Radio (NR) radio access network, and the narrow channel bandwidth is a NR narrow channel bandwidth.

5. The method of claim 4 wherein the narrow channel bandwidth is in a range of and including 3 Megahertz (MHz) to 5 MHz.

6. The method of claim 1 wherein the explicit or implicit early indication or implicit inference is during initial access.

7. The method of claim 1 wherein determining that the UE is to operate in accordance with the narrow channel bandwidth comprises determining that that the UE is to operate in accordance with the narrow channel bandwidth based on an explicit early indication.

8. The method of claim 7 further comprising receiving the explicit early indication from a network node during initial access.

9. The method of claim 7 wherein the explicit early indication is:
a dedicated synch raster for narrow channel bandwidth;
a Global Synchronization Channel Number (GSCN) that is mapped, via a predefined mapping, to the narrow channel bandwidth;
a Synchronization Signal Block (SSB) frequency position that is mapped, via a predefined mapping, to the narrow channel bandwidth;
a Cell identity (ID) derived from a detected Primary Synchronization Signal (PSS) and Secondary Synchronization Signal, SSS, where the Cell ID is one of a predefined set of Cells IDs associated to narrow channel bandwidths;
a Cell ID, derived from a detected PSS and SSS, where the Cell ID is mapped via a predefined mapping to the narrow channel bandwidth;
a detected Demodulation Reference Signal (DMRS) sequence; or
a scrambling sequence used to scramble a specific part of a detected DMRS sequence used for a Physical Broadcast Channel (PBCH).

10-15. (canceled)

16. The method of claim 1 wherein determining that the UE is to operate in accordance with the narrow channel bandwidth comprises determining that that the UE is to operate in accordance with the narrow channel bandwidth based on an implicit early indication.

17. The method of claim 16 further comprising receiving the implicit early indication from a network node during initial access.

18. The method of claim 16 wherein the implicit early indication is:
operation of the UE in a specific frequency band;
obtained by attempting to detect or receive a Synchronization Signal Block (SSB) or a Physical Downlink Control Channel (PDCCH) in a Control Resource Set (CORESET) #0 with two different hypotheses, one in which the SSB or PDCCH is punctured and another in which the SSB or PDCCH is not punctured; or
a pre-configuration that the UE is to always operate in a narrow channel bandwidth when the UE operates in a specific frequency band.

19-20. (canceled)

21. The method of claim 1 wherein determining that the UE is to operate in accordance with the narrow channel bandwidth comprises determining that that the UE is to operate in accordance with the narrow channel bandwidth based on an implicit early inference.

22. The method of claim 21 wherein the implicit early inference is obtained by Demodulation Reference Signal DMRS estimation for a Physical Broadcast Channel (PBCH) using one or more hypotheses in which some symbols are punctured.

23. The method of claim 21 wherein the implicit early inference is obtained by Demodulation Reference Signal (DMRS) estimation for a Physical Broadcast Channel (PBCH) using a first set of one or more hypotheses in which there is no puncturing and a second set of one or more hypotheses in which some symbols are punctured.

24. The method of claim 21 wherein the implicit early inference is based on:
metrics calculated for each of one or more Synchronization Signal Block (SSB) candidates for each of the first and second sets of hypotheses;
one or more guard bands of an associated transmission bandwidth; or
received power levels between subsets of resource elements that may be punctured and a subset of resource elements that are not punctured.

25-28. (canceled)

29. A User Equipment (UE) for a wireless network, the UE comprising:
a communication interface comprising a transmitter and a receiver; and
processing circuitry associated with the communication interface, the processing circuitry configured to cause the UE to:
determine, based on an explicit or implicit early indication or implicit inference, that the UE is to operate in accordance with a narrow channel bandwidth; and
operate in accordance with a result of the determining.

30. (canceled)

31. A method performed by a network node, the method comprising:
transmitting to a User Equipment (UE) an explicit or implicit early indication that the UE is to operate in accordance with a narrow channel bandwidth, wherein the narrow channel bandwidth is a channel bandwidth in which one or more channels or signals transmitted on an associated cell are punctured, prior to transmission, as a result of a bandwidth of the one or more channels or signals exceeding the narrow channel bandwidth.

32-34. (canceled)

35. The method of claim 31 wherein the narrow channel bandwidth is in a range of and including 3 MHz to 5 MHz.

36. The method of claim 31 wherein the explicit or implicit early indication is transmitted during initial access of the UE.

37. The method of claim 31 wherein the explicit or implicit early indication is an explicit early indication.

38. The method of claim 37 wherein the explicit early indication is:
a dedicated synch raster for narrow channel bandwidth;
a Global Synchronization Channel Number (GSCN) that is mapped, via a predefined mapping, to the narrow channel bandwidth;
a Synchronization Signal Block (SSB) frequency position that is mapped, via a predefined mapping, to the narrow channel bandwidth;
a Cell identity (ID) derived from a detected Primary Synchronization Signal (PSS) and Secondary Synchronization Signal, SSS, where the Cell ID is one of a predefined set of Cells IDs associated to narrow channel bandwidths;
a Cell ID, derived from a detected PSS and SSS, where the Cell ID is mapped via a predefined mapping to the narrow channel bandwidth;
a detected Demodulation Reference Signal (DMRS) sequence; or
a scrambling sequence used to scramble a specific part of a detected DMRS sequence used for a Physical Broadcast Channel (PBCH).

39-49. (canceled)
